(19) United States
(12) Patent Application Publication
(10) Pub. No.: US 2010/0247976 A1
(43) Pub. Date: Sep. 30, 2010

(54) GLASS SUBSTRATE FOR A MAGNETIC DISK AND METHOD OF MANUFACTURING THE SAME

(75) Inventors: Takanori Mizuno, Tokyo (JP); Junpei Fukada, Tokyo (JP); Hiroshi Tsuchiya, Tokyo (JP)

Correspondence Address: AMSTER, ROTHSTEIN & EBENSTEIN LLP, 90 PARK AVENUE, NEW YORK, NY, 10016, US

(73) Assignee: HOYA CORPORATION, Tokyo (JP)

(21) Appl. No.: 12/749,071

(22) Filed: Mar. 29, 2010

(30) Foreign Application Priority Data
Mar. 30, 2009 (JP) 2009-081797
Dec. 28, 2009 (JP) 2009-296924

(51) Int. Cl. G11B 5/73; C03C 19/00

(52) U.S. Cl. 428/846.3; 65/61

(57) ABSTRACT

A glass substrate is for use in a magnetic disk. The glass substrate is formed by using a plate-like glass produced by a float method and having a pair of main surfaces. One surface of the main surfaces, which is formed with a tin layer when producing the plate-like glass by the float method, is caused to serve as a surface not for use in magnetic recording and the other surface formed with no tin layer is caused to serve as a surface for use in magnetic recording.

### CROSS REFERENCE TO RELATED APPLICATIONS

This application claims the benefit of priority from Japanese Patent Application No. 2009-081797, filed on Mar. 30, 2009, and Japanese Patent Application No. 2009-296924, filed on Dec. 28, 2009, the disclosures of which are incorporated herein in their entirety by reference.

### TECHNICAL FIELD

This invention relates to a glass substrate for a magnetic disk adapted to be mounted in a hard disk drive (HDD) and to a method of manufacturing the same.

### BACKGROUND

A glass substrate has been used as one of substrates for magnetic disks for use in HDDs, which are suitable for increasing the recording density. The glass substrate has a higher rigidity than a metal substrate and thus is suitable for an increase in rotational speed of the HDD. Since the glass substrate can obtain a smooth and flat surface, it can reduce the flying height of a magnetic head and thus is suitable for improving the S/N ratio and increasing the recording density.

In general, a glass substrate for a magnetic disk is manufactured by processes including a process of heating and melting a glass material to prepare a molten glass, a process of producing a plate-like glass from the molten glass and then forming it into a disk shape, and a process of processing and polishing the disk-shaped glass.

For producing the plate-like glass from the molten glass, a float method, for example, is employed (JP-A-2006-99857). The plate-like glass produced by the float method has a feature in that it has mirror-finished main surfaces from the beginning and thus is excellent in flatness.

### SUMMARY OF THE INVENTION

Since molten tin is used in its production process, the plate-like glass produced by the float method has a surface (bottom surface) that was in contact with the molten tin and a surface (top surface) on its opposite side, so that a tin-diffused layer with a thickness of about 10 μm to 50 μm is inevitably formed on the bottom surface side. If a glass substrate for a magnetic disk is formed in the state where the tin remains in the surface of the plate-like glass as described above, the function as the magnetic disk is extremely reduced. Therefore, when manufacturing a glass substrate for a magnetic disk by the use of a plate-like glass produced by the float method, it is necessary to remove tin contained in a glass surface by a grinding process.

FIG. 2 shows one example of a specific sequence of manufacturing processes of a glass substrate for a magnetic disk by the use of a plate-like glass produced by the float method. As shown in FIG. 2, in these manufacturing processes, a plate-like glass produced by the float method is cut into a rectangular shape larger than a desired disk shape (step S1), then the rectangular plate-like glass is processed into the disk shape by, for example, scribing (step S2). Then, a tin-diffused layer on the bottom surface side of the disk-shaped glass is removed by grinding (step S3), then edge faces of the disk-shaped glass are polished (step S4). Then, the roughness of main surfaces of the disk-shaped glass is adjusted by a first polishing process (step S5) and a second polishing process (step S6), then the surfaces of the disk-shaped glass are chemically strengthened (step S7).

However, there is a problem that the grinding process for removing the tin-diffused layer on the bottom surface side of the disk-shaped glass is costly and thus increases the manufacturing cost of a glass substrate for a magnetic disk. Further, a deep crack may occur on the glass surface due to the grinding process. In order to remove the crack, it is necessary that a polishing margin be adjusted to be large in the polishing process. However, it has been known that since the polishing process does not assume such an adjustment of the polishing margin, there may arise a problem such as the remaining of the crack due to the shortage of the polishing margin.

In the meantime, the recording density of a magnetic disk has been increasing year by year and even a magnetic disk having a recording capacity of 100 GB or more on its one side has been developed. Currently, the magnetic disk satisfies a required recording capacity as the sum of recording capacities on both sides thereof. However, if the recording density increases in this manner, the required recording capacity will be satisfied only on one side of a magnetic disk particularly in the case of an electronic device that does not require a so large recording capacity. If the required recording capacity is satisfied only on one side of the magnetic disk as described above, the number of components can be reduced on the HDD side such that a single magnetic head is sufficient for one magnetic disk. This is advantageous in terms of cost and further makes it possible to achieve a reduction in thickness of the HDD. Therefore, it is expected that there will be an increasing need for a magnetic disk having a magnetic layer only on one side thereof.

This invention has been made in view of the above and has an object to provide a glass substrate for a magnetic disk that can be easily manufactured from a plate-like glass produced by the float method and further to provide a method of manufacturing such a glass substrate.

According to this invention, there is provided a glass substrate for a magnetic disk, the glass substrate being formed by using a plate-like glass produced by a float method and having a pair of main surfaces, wherein one surface of the main surfaces, which is formed with a tin layer when producing the plate-like glass by the float method, is caused to serve as a surface not for use in magnetic recording and the other surface formed with no tin layer is caused to serve as a surface for use in magnetic recording.

According to this configuration, only one of the main surfaces, which was not in contact with molten tin in the production of the plate-like glass, is caused to serve as a surface for use in magnetic recording and, therefore, grinding for removal of tin is not required so that it is possible to realize the glass substrate for the magnetic disk that can be easily obtained. It is also possible to prevent the occurrence of a crack otherwise caused by a grinding process.

According to this invention, there is provided a magnetic disk, wherein at least a magnetic layer is formed only on the other surface, formed with no tin layer, of the glass substrate for the magnetic disk so that only the other surface formed with no tin layer serves as a magnetic recording surface.

According to this invention, there is provided a method of manufacturing a glass substrate for a magnetic disk, comprising obtaining a plate-like glass by a float method; and polishing only one surface of a pair of main surfaces, which is formed with no tin layer, of the plate-like glass as a surface for use in magnetic recording.

According to this method, only one of the main surfaces, which was not in contact with molten tin in the production of the plate-like glass, is caused to serve as a surface for use in magnetic recording and, therefore, grinding for removal of tin is not required so that it is possible to manufacture the glass substrate for the magnetic disk at low cost. It is also possible to prevent the occurrence of a crack otherwise caused by a grinding process.

According to this invention, there is provided a method of manufacturing a magnetic disk, comprising: forming at least a magnetic layer only on the one surface, formed with no tin layer, of the glass substrate manufactured by the aforementioned glass substrate manufacturing method.

According to this invention, a plate-like glass is produced by the float method and only one of a pair of main surfaces, which is formed with no tin layer, of the plate-like glass is polished as a surface for use in magnetic recording. Therefore, the occurrence of a crack otherwise caused by a grinding process can be prevented and it is possible to provide a glass substrate for a magnetic disk that can be easily manufactured from the plate-like glass produced by the float method and further to provide a method of manufacturing such a glass substrate.

### BRIEF DESCRIPTION OF THE DRAWINGS

FIG. 1 is a diagram showing one example of a specific sequence of manufacturing processes of a glass substrate for a magnetic disk according to an embodiment of this invention; and

FIG. 2 is a diagram showing one example of a specific sequence of manufacturing processes of a conventional glass substrate for a magnetic disk.

### DETAILED DESCRIPTION OF EXEMPLARY EMBODIMENTS

Paying attention to the fact that there will be a need for a glass substrate for a magnetic disk having a magnetic layer only on its one side, i.e. a glass substrate adapted to use only one of its main surfaces as a surface for use in magnetic recording, and that a plate-like glass produced by the float method is formed with a tin layer at only one of its main surfaces, the present inventor has found that a grinding process for removing the tin layer can be omitted by causing only the main surface formed with no tin layer by the float method to serve as a surface for use in magnetic recording, and has completed this invention.

That is, the essence of this invention is to produce a plate-like glass by the float method and to polish only one of a pair of main surfaces, which is formed with no tin layer, of the plate-like glass as a surface for use in magnetic recording, thereby easily manufacturing a glass substrate for a magnetic disk from the plate-like glass produced by the float method.

Hereinbelow, a glass substrate for a magnetic disk as an exemplary embodiment of this invention will be described.

As a material of the glass substrate for the magnetic disk, use can be made of an aluminosilicate glass, a sodalime glass, a borosilicate glass, or the like. Particularly, the aluminosilicate glass can be preferably used because it can be chemically strengthened and it can provide the glass substrate for the magnetic disk excellent in flatness of main surfaces thereof and in substrate strength.

In this embodiment, a plate-like glass for forming the glass substrate for the magnetic disk is produced by the float method. Hereinbelow, an outline of the float method will be briefly explained.

In the float method, a molten glass is introduced into a float bath filled with molten tin to form a molten glass layer on a molten tin layer, then the molten glass layer is cooled to be a plate-like glass, and then the plate-like glass is separated from the molten tin layer. Then, surfaces of the plate-like glass are cleaned, thereby producing a desired plate-like glass.

The molten glass layer is formed by introducing the molten glass, prepared/mixed according to the composition of a glass product, into the float bath filled with the molten tin. Since the molten glass has a specific gravity smaller than that of the molten tin, a two-layer structure is formed in the float bath in which the molten glass layer is an upper layer and the molten tin layer is a lower layer. In this state, an upper surface of the molten tin layer being the lower layer is formed as a flat and smooth surface by the surface tension. On the other hand, a lower surface of the molten glass layer, which is in contact with the upper surface of the molten tin layer to form an interface therebetween, is formed as a flat and smooth surface in conformity with the upper surface of the molten tin layer. Further, an upper surface of the molten glass layer is formed as a flat and smooth surface by the surface tension of the molten glass itself. In this manner, the molten glass layer has the upper and lower surfaces both being flat and smooth and is floating as the upper layer in the float bath.

Then, the molten glass layer is cooled. The melting point of glass is higher than that of tin so that when the molten glass layer and the molten tin layer in the float bath are slowly cooled, the molten glass layer starts to solidify earlier. By maintaining the temperature less than the melting point of glass and not less than the melting point of tin, the molten glass layer completely solidifies to be a plate-like glass which is floating and held on the molten tin. In this process, no external force is applied to either the upper surface or the lower surface of the molten glass layer when the molten glass solidifies, so that the molten glass layer solidifies to be the plate-like glass while maintaining the flat and smooth state. Therefore, a pair of upper and lower main surfaces of the obtained plate-like glass are both mirror-finished.

Then, the plate-like glass floating and held on the molten tin is separated from the molten tin layer by lift-out rolls or the like. Then, the plate-like glass is cooled to room temperature, then the tin component adhering to the surfaces of the plate-like glass is removed by a cleaning process or the like, thereby obtaining a desired plate-like glass.

As described above, by producing the plate-like glass by the float method, the pair of its main surfaces can both be mirror-finished. Further, by adjusting the amount of the molten glass when introducing the molten glass on the molten tin, the molten glass layer can be formed to a desired thickness of several mm to several hundred mm. Further, since the plate-like glass can be produced in the state where it is floating and held on the molten tin through its production processes, transfer and so on of the plate-like glass in its production processes can be easily carried out. In this embodiment, the glass substrate for the magnetic disk is not limited to its composition and thickness as long as the plate-like glass is produced by the above-mentioned float method.

In the float method, since the molten glass layer solidifies in the state of floating on the molten tin layer, part of the tin component enters the inner side of the molten glass layer at its surface on the molten tin layer side. Therefore, even if the plate-like glass is separated from the molten tin layer, the surface of the plate-like glass on the side where the molten tin was present contains the tin component and, thus, even if this surface of the plate-like glass is cleaned, the tin component cannot be completely removed.

The glass substrate for the magnetic disk according to this embodiment is a glass substrate for a magnetic disk having a pair of main surfaces, wherein one of the pair of main surfaces, which is formed with a tin layer when producing a plate-like glass by the float method, is caused to serve as a surface not for use in magnetic recording and the other main surface formed with no tin layer is caused to serve as a surface for use in magnetic recording. As described above, when producing the plate-like glass by the float method, even if the plate-like glass is separated from the molten tin layer, the surface of the plate-like glass on the side where the molten tin layer was present contains the tin. Therefore, in the manufacture of a conventional glass substrate for a magnetic disk wherein both main surfaces of the glass substrate are used as magnetic recording surfaces, a grinding process for removing the tin is required and it may happen that a crack caused by the grinding process is not removed even by a subsequent polishing process, thus leading to a defect.

In view of such a problem, according to this embodiment, since the main surface containing the tin is not used as a magnetic recording surface, it is not necessary to carry out grinding for removal of the tin and thus it is possible to realize a glass substrate for a magnetic disk that can be easily obtained. Further, since the grinding process is omitted, it is possible to maintain the smoothness of the mirror-finished surfaces of the plate-like glass.

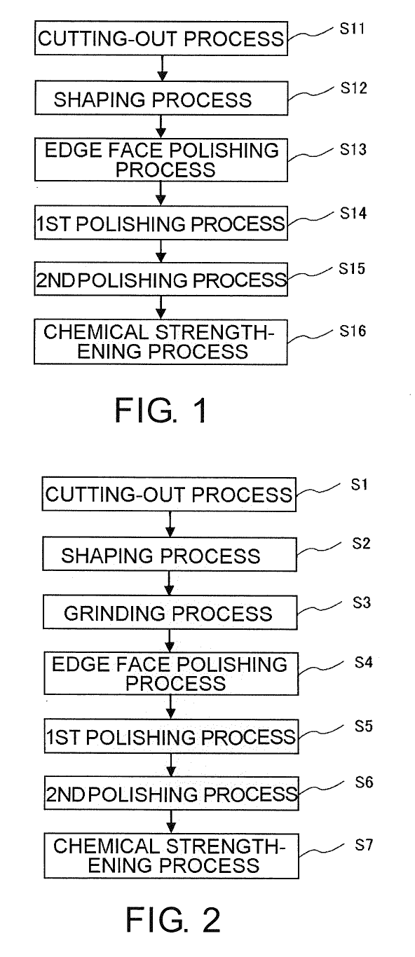

Now, a description will be given of a method of manufacturing a glass substrate for a magnetic disk according to this embodiment. FIG. 1 is a diagram showing one example of a specific sequence of manufacturing processes of the glass substrate for the magnetic disk according to this embodiment.

As shown in FIG. 1, the manufacturing processes of the glass substrate for the magnetic disk according to this embodiment include Cutting-Out Process for cutting a plate-like glass produced by the float method into a rectangular shape larger than a desired disk shape (step S11); Shaping Process (scribing process for cutting into a ring shape and chamfering process for forming chamfered faces at end portions (outer peripheral end portion and inner peripheral end portion) (chamfered face forming process)) (step S12); Edge face Polishing Process (outer peripheral end portion and inner peripheral end portion) (step S13); Main Surface Polishing Process (first and second polishing processes) (step S14) (step S15); and Chemical Strengthening Process (step S16). The order of the processes may be appropriately changed. As seen from the above, in the method of manufacturing the glass substrate for the magnetic disk according to this embodiment, since only one main surface (main surface formed with no tin layer) of the plate-like glass produced by the float method is caused to serve as a surface for use in magnetic recording, the glass substrate for the magnetic disk is manufactured without carrying out a grinding process for removal of tin remaining at the other main surface of the plate-like glass.

(1) Cutting-Out Process

First, in the cutting-out process, a plate-like glass produced by the float method using a molten glass as a material is cut into a rectangular shape larger than a desired disk shape.

(2) Shaping Process (scribing process for cutting into a ring shape and chamfering process for forming chamfered faces at end portions (outer peripheral end portion and inner peripheral end portion) (chamfered face forming process))

In the scribing process, for example, cut lines are formed at outer and inner peripheral portions of the rectangular plate-like glass from its one main surface side by the use of an ultra-hard cutter such as a glass cutter or a diamond cutter and then heating is carried out, thereby obtaining a ring-shaped glass substrate. In the chamfering process, grinding is applied to an outer peripheral edge face and an inner peripheral edge face by the use of diamond grindstones, thereby carrying out predetermined chamfering to form chamfered faces.

(3) Edge face Polishing Process

In the edge face polishing process, the outer peripheral edge face and the inner peripheral edge face of the glass substrate are mirror-polished by a brush polishing method. In this event, as polishing abrasive particles, use can be made of, for example, a slurry (free abrasive particles) containing cerium oxide abrasive particles. By this edge face polishing process, contaminants, damages, cracks, and the like on the edge faces of the glass substrate are removed so that the edge faces of the glass substrate are finished to a state that can prevent precipitation of sodium or potassium ions that would otherwise cause corrosion.

(4) First Polishing Process

The first polishing process is first carried out as a main surface polishing process. The first polishing process mainly aims to remove cracks, strains, and the like remaining on both main surfaces of the glass substrate and to carry out a preliminary roughness adjustment for achieving a target surface roughness in a final polishing process. In this first polishing process, both main surfaces of the glass substrate are polished using a double-side polishing machine having a planetary gear mechanism with the use of a hard resin polisher. Cerium oxide abrasive particles can be used as a polishing agent.

In this first polishing process, the polishing is carried out to provide a surface roughness low enough to prevent the elution of a component (e.g. alkali metal) forming the glass substrate particularly from the main surface (where no magnetic recording layer will be provided), on the side opposite to a magnetic recording surface, of the glass substrate. For example, the surface roughness low enough to prevent the elution of the component forming the glass substrate is such that the arithmetic mean roughness Ra measured by an atomic force microscope (AFM) with a resolution of 256×256 pixels per 2 μm×2 μm square is 0.005 μm or less.

(5) Second Polishing Process

Then, the second polishing process is carried out as a final polishing process. The second polishing process aims to finish only one of both main surfaces, which will serve as the magnetic recording surface, of the glass substrate into a mirror surface. In this second polishing process, the main surface of the glass substrate is mirror-polished using a double-side polishing machine having a planetary gear mechanism with the use of a soft resin foam polisher. As a slurry, use can be made of cerium oxide abrasive particles, colloidal silica, or the like finer than the cerium oxide abrasive particles used in the first polishing process.

(6) Chemical Strengthening Process

In the chemical strengthening process, chemical strengthening is applied to the glass substrate having been subjected to the above-mentioned polishing processes. As a chemical strengthening solution for use in the chemical strengthening, use can be made of, for example, a mixed solution of potassium nitrate (60%) and sodium nitrate (40%). The chemical strengthening is carried out by heating the chemical strengthening solution to 300° C. to 400° C., preheating the cleaned glass substrate to 200° C. to 300° C., and immersing the glass substrate in the chemical strengthening solution for 3 hours to 4 hours. In order to chemically strengthen the entire surfaces of the glass substrate, the immersion is preferably carried out in the state where a plurality of glass substrates are placed in a holder so as to be held at their edge faces.

By carrying out the immersion in the chemical strengthening solution as described above, lithium ions and sodium ions in surface layers of the glass substrate are replaced by sodium ions and potassium ions having relatively large ionic radii in the chemical strengthening solution, respectively, so that the glass substrate is strengthened. By switching the order between the second polishing process and the chemical strengthening process, it is possible to manufacture a glass substrate for a magnetic disk having a lower surface roughness.

Hereinbelow, the exemplary embodiment of this invention will be specifically described using the following Examples. It is to be noted that this invention is not limited to the following Examples.

### EXAMPLE

A glass substrate for a magnetic disk of this Example was manufactured through (1) Cutting-Out Process, (2) Shaping Process, (3) Edge face Polishing

Process, (4) Main Surface Polishing Process, and (5) Chemical Strengthening Process which will be described hereinbelow.

A plate-like glass for use in the manufacture of the glass substrate for the magnetic disk was produced by the float method. In the float method, a molten glass solution (molten glass) was caused to flow on molten tin and to solidify as it is. Both main surfaces of the plate-like glass were a glass free surface (upper surface (top surface) of the plate-like glass) and a glass/tin interface (tin surface (bottom surface) of the plate-like glass) which were mirror surfaces with Ra of 0.001 μm or less.

(1) Cutting-Out Process

The plate-like glass in the form of an aluminosilicate glass with a thickness of 0.95 mm produced by the float method was cut into a rectangular shape with a predetermined size. Then, circular cut lines describing approximate edges on the outer and inner peripheral sides of a region to be a glass substrate for a magnetic disk were formed on the top surface of the rectangular plate-like glass by a glass cutter. As the aluminosilicate glass, use was made of a glass for chemical strengthening which contains SiO₂: 58 mass % to 75 mass %, Al₂O₃: 5 mass % to 23 mass %, Li₂O: 3 mass % to 10 mass %, and Na₂O: 4 mass % to 13 mass %. Then, the top surface side of the plate-like glass formed with the cut lines was heated in its entirety by a heater to advance the cut lines to the bottom surface side of the plate-like glass, thereby cutting out a glass disk (mirror-surface plate glass) having a predetermined diameter.

(2) Shaping Process

Then, grinding was applied to an outer peripheral edge face and an inner peripheral edge face of the glass disk to obtain an outer diameter of 65 mm and an inner diameter (diameter of a circular hole at a central portion) of 20 mm, then predetermined chamfering was applied to the outer peripheral edge face and the inner peripheral edge face. In this event, the surface roughness of the edge faces of the glass disk was about 2 μm in Rmax. In general, a magnetic disk with an outer diameter of 65 mm is used in a 2.5-inch HDD.

(3) Edge face Polishing Process

Then, by brush polishing, the outer and inner peripheral edge faces of the glass disk were polished to a surface roughness of 0.4 μm in Rmax and about 0.1 μm in Ra while rotating the glass disk. Then, the surfaces of the glass disk having been subjected to the above-mentioned edge face polishing were washed with water.

(4) Main Surface Polishing Process

Then, a first polishing process for removing remaining minute cracks, strains, foreign matter, and the like was carried out using a double-side polishing machine. In the double-side polishing machine, the glass disk held by a carrier was placed in tight contact between upper and lower polishing surface plates each attached with a polishing pad, the carrier was brought into mesh with a sun gear and an internal gear, and the glass disk was pressed between the upper and lower polishing surface plates. Then, by rotating the upper and lower polishing surface plates while supplying a polishing agent between the polishing pads and both main surfaces, i.e. the surfaces to be polished, of the glass disk, the carrier revolved around the sun gear, i.e. made an orbital motion, while rotating on its axis on the upper and lower polishing surface plates so that both main surfaces of the glass disk were polished simultaneously. Specifically, using a hard polisher (hard urethane foam) as the polisher, the first polishing process was carried out.

Then, a second polishing process was carried out using the same double-side polishing machine used in the first polishing process while changing the polisher to a soft-polisher (suede) polishing pad. This second polishing process was a mirror-polishing process for finishing the main surface of the glass disk to a smooth mirror surface with a surface roughness of, for example, about 3 nm or less in Rmax while maintaining the flat surface obtained in the first polishing process.

In the second polishing process, the main surface to be polished is a main surface having no tin-diffused layer (surface for use in magnetic recording). This main surface is polished as a surface for use in magnetic recording. Herein, the polishing for a surface for use in magnetic recording represents polishing carried out under conditions sufficient for satisfying the quality required for a glass substrate for a magnetic disk and, specifically, a target surface roughness Ra is 0.2 nm or less.

(5) Chemical Strengthening Process

Then, after the above-mentioned main surface polishing process, chemical strengthening was applied to the glass disk having been subjected to cleaning. Ions present in the surface of the glass disk (e.g. lithium ions and sodium ions in the case of the aluminosilicate glass) are replaced by ions (sodium ions and potassium ions) having greater ionic radii. The rigidity of the glass disk is increased by performing ion exchange with atoms having greater ionic radii to apply a compressive stress to the surface of the glass disk.

If (5) Chemical Strengthening Process described above is not carried out, a simple chemical treatment may be carried out after (3) Edge face Polishing Process described above.

The above-mentioned processes were carried out while maintaining the glass surface containing tin and the glass surface containing no tin in a fixed relationship (i.e. in a state where the main surfaces can be distinguished from each other) when shifting between the processes (1) to (5). In the manner as described above, a glass substrate for a magnetic disk of this Example was obtained.

On the main surface, containing no tin, of the glass substrate thus obtained, an adhesive layer of a Cr alloy, a soft magnetic layer of a CoTaZr-based alloy, an underlayer of Ru, a perpendicular magnetic recording layer of a CoCrPt-based alloy, a protective layer of hydrogenated carbon, and a lubricating layer of perfluoropolyether were formed in this order, thereby manufacturing a perpendicular magnetic recording disk. This structure is one example of the structure of a perpendicular magnetic recording disk. Magnetic layers and so on may be formed as an in-plane magnetic recording disk.

### Comparative Example 1

On a main surface, containing tin, of a glass substrate for a magnetic disk obtained in the same manner as in Example 1, an adhesive layer of a Cr alloy, a soft magnetic layer of a CoTaZr-based alloy, an underlayer of Ru, a perpendicular magnetic recording layer of a CoCrPt-based alloy, a protective layer of hydrogenated carbon, and a lubricating layer of perfluoropolyether were formed in this order, thereby manufacturing a perpendicular magnetic recording disk.

### Comparative Example 2

After carrying out the processes (1) to (3) in the same manner as in Example 1, a main surface containing tin was polished as a surface for use in magnetic recording in the first and second polishing processes and then the chemical strengthening process was carried out, thereby manufacturing a glass substrate for a magnetic disk. Thereafter, on this main surface containing tin, an adhesive layer of a Cr alloy, a soft magnetic layer of a CoTaZr-based alloy, an underlayer of Ru, a perpendicular magnetic recording layer of a CoCrPt-based alloy, a protective layer of hydrogenated carbon, and a lubricating layer of perfluoropolyether were formed in this order, thereby manufacturing a perpendicular magnetic recording disk.

The magnetic disks thus manufactured by the foregoing examples were inspected. A head crash test was performed for each magnetic disk by using an inspection head with a flying height of 8 nm and causing the inspection head to fly over the magnetic disk. As a result, no head crash failure occurred with respect to any of the perpendicular magnetic recording disk using the main surface, containing no tin, of the glass substrate as a magnetic recording surface (Example 1) and the perpendicular magnetic recording disks each using the main surface, containing tin, of the glass substrate as a magnetic recording surface (Comparative Examples 1 and 2).

Then, a head crash test was performed for each magnetic disk by the use of an inspection head with a flying height of 5 nm. As a result, head crash failure occurred with respect to the perpendicular magnetic recording disks each using the main surface, containing tin, of the glass substrate as a magnetic recording surface (Comparative Examples 1 and 2). On the other hand, no head crash failure occurred with respect to the perpendicular magnetic recording disk using the main surface, containing no tin, of the glass substrate as a magnetic recording surface (Example 1). Accordingly, it is necessary to manufacture a perpendicular magnetic recording disk using a main surface, containing no tin, of a glass substrate as a magnetic recording surface.

As described above, according to this embodiment, a plate-like glass is produced by the float method and only one of a pair of main surfaces, which is formed with no tin layer, of the plate-like glass is polished as a surface for use in magnetic recording. Therefore, it is not necessary to carry out grinding for removal of tin and thus a glass substrate for a magnetic disk can be manufactured at low cost. Further, since polishing is carried out so that a main surface containing tin is caused to serve as a non-recording surface and only a main surface containing no tin is caused to serve as a magnetic recording surface, it is possible to obtain a glass substrate for a magnetic disk which is excellent with no occurrence of head crash even at a head flying height of 5 nm.

This invention is not limited to the above-mentioned embodiment and can be carried out by appropriately changing it. The numerical values, materials, sizes, processing sequences, and so on in the above-mentioned embodiment are only examples and this invention can be carried out by changing them in various ways within a range capable of exhibiting the effect of this invention. Other than that, this invention can be carried out in various ways within a range not departing from the object of this invention.

This invention is applicable to a glass substrate for a magnetic disk for use in a HDD of a personal computer, a portable music device, or the like.

What is claimed is:

1. A glass substrate for a magnetic disk, the glass substrate being formed by using a plate-like glass produced by a float method and having a pair of main surfaces,
wherein one surface of the main surfaces, which is formed with a tin layer when producing the plate-like glass by the float method, is caused to serve as a surface not for use in magnetic recording and the other surface formed with no tin layer is caused to serve as a surface for use in magnetic recording.

2. A magnetic disk, wherein at least a magnetic layer is formed only on the other surface, formed with no tin layer, of the glass substrate for the magnetic disk according to claim 1 so that only the other surface formed with no tin layer serves as a magnetic recording surface.

3. A method of manufacturing a glass substrate for a magnetic disk, comprising:
obtaining a plate-like glass by a float method; and
polishing only one surface of a pair of main surfaces, which is formed with no tin layer, of the plate-like glass as a surface for use in magnetic recording.

4. A method of manufacturing a magnetic disk, comprising:
forming at least a magnetic layer only on the one surface, formed with no tin layer, of the glass substrate manufactured by the method according to claim 3.
